(19) United States
(12) Patent Application Publication
(10) Pub. No.: US 2011/0012749 A1
(43) Pub. Date: Jan. 20, 2011

(54) Data transmission apparatus for household appliances, functional component and household appliance

(76) Inventor: Rudolf Lonski, Golling (AT)

Correspondence Address: WILLIAM D. BRENEMAN, ESQ.;BRENEMAN & GEORGES, 3150 COMMONWEALTH AVENUE, ALEXANDRIA, VA, 22305, US

(21) Appl. No.: 12/805,174

(22) Filed: Jul. 15, 2010

(30) Foreign Application Priority Data
Jul. 16, 2009 (DE) 10 2009 033 477.7

(51) Int. Cl. G05B 19/02

(52) U.S. Cl. 340/825.22

(57) ABSTRACT

The invention proposes a data transmission apparatus (8, 17, 31; 45, 46) for household appliances (1, 10, 20, 40), particularly washing machines, dishwashers or the like, for sending and/or receiving data between at least two functional components (2, 5, 11, 16, 21, 22, 26, 42, 43) for the household appliance. In order to allow improved data transmission, the data transmission apparatus has an optical interface (6, 7, 17, 28, 29, 30, 31, 45). In addition, the invention proposes a functional component for a household appliance and also a household appliance.

The invention relates to a data transmission apparatus for household appliances according to the preamble of claim 1, a functional component for a household appliance according to the preamble of claim 8 and to a household appliance according to the preamble of claim 12.

The prior art discloses commercially available household appliances such as washing machines, dishwashers, possibly even coffee/espresso machines or the like, in which individual functional components which are permanently integrated in the household appliance send data to other permanently integrated functional components. By way of example, the central controller of a dishwasher sends the combined dosing apparatus, which is permanently integrated in the dishwasher, commands regarding which washing substance needs to be dispensed into the working space of the dishwasher at what time on the basis of the cleaning program which is to be executed. For this purpose, the permanently installed functional components are usually hardwired to one another.

It is an object of the invention to propose a data transmission apparatus for household appliances, a functional component for a household appliance and a household appliance in which improved data transmission is made possible.

The object is achieved, on the basis of a data transmission apparatus, a functional component for a household appliance and a household appliance of the type cited at the outset, by the characterizing features of claims 1, 8 and 12.

The measures cited in the dependent claims allow advantageous embodiments and developments of the invention.

Accordingly, a data transmission apparatus according to the invention for household appliances is distinguished in that it has an optical interface. The advantage of this is that short circuits can be avoided upon the infiltration of water, for example in contrast to electrical lines in hardwiring. It is also possible for double insulation, which is used in electrical appliances in connection with water-carrying components, to be avoided to some extent, particularly when the transmission needs to take place over relatively long distances. It is therefore also possible to dispense with components. In addition, a low interference rate, a low susceptibility to error and a low loss rate are possible for optical transmissions. Furthermore, it is possible to save energy, particularly if a long cable run for an electrical line were necessary, because a long cable automatically has a higher electrical resistance than a corresponding shorter one.

If optical transmission takes place between individual components, for example, these components can often be encapsulated without particular design complexity. However, setting up an electrical connection between two components requires a cable run to be laid between the two, for example, which would then in turn breach the encapsulation. It would also be possible for external contacts to be provided on the respective component in order to set up an electrical connection. However, these can easily corrode or have deposits on them, such as lime. These drawbacks can at least to some extent be avoided or alleviated, in principle, by optical interfaces.

The term “data” is intended to be understood to mean parameters, commands, numbers, that is to say any possible information, in principle. Within the context of the invention, data transmission means the sending and/or receiving of data. The data transmission can accordingly take place only in one direction or else as interchange reciprocally in both directions between the components.

Household appliances within the context of the invention are dishwashers, washing machines or the like, for example. A functional component is a component or an apparatus of the household appliance which performs one or more particular functions. By way of example, it may be the control unit of the household appliance, that is to say the central control device of the household appliance, for example. Control is intended to be understood to mean a control and/or regulatory process. Alternatively, a functional component may be the control panel of the household appliance, for example, which the user of the household appliance can use to select and set the cleaning program, for example, inter alia. Alternatively, a functional component may be a combined dosing apparatus which, in dishwashers, is incorporated in the loading door of the machine, for example, and which doses or dispenses the relevant cleaning substances, liquid cleaners, rinse aids, possibly what are known as cleaning tabs or the like into the working space of the household appliance.

Consistently, the central control unit of the household appliance, the control panel and the combined dosing apparatus are permanently incorporated in the household appliance as functional components.

Alternatively, there is also the option of providing functional components which are not permanently installed with the household appliance. By way of example, it is also possible to use dosing apparatuses as a separate dosing insert in household appliances. In the case of dishwashers, these may be put into the working space, for example, together with the tableware which is to be cleaned. The dosing inserts can also supply the relevant detergent or dish detergent and dispense or dose it into the working space during the cleaning process. Such a dosing insert can generally operate under machine control, that is to say they have a connection to be control unit of the household appliance which in turn controls or regulates the dosing of the dosing insert. It is also conceivable to use an autonomously operating dosing insert. In contrast to the machine-controlled insert, this dosing insert has conductance, temperature, pH sensors or the like, for example, and thus itself determines when and in what way detergents need to be dispensed. The dosing insert may furthermore have an autonomous power supply. It is also possible to provide dosing inserts which operate only to some extent independently of the control unit of the household appliance, e.g. can transmit data to the control unit of the household appliance, can to some extent also receive commands from the control unit of the household appliance or whose power supply is dependent on the household appliance.

An optical interface within the meaning of the invention is a data transmission site for connecting appliances, components or the like which allows transmission of data, interchange of data or communication by transmitting light. It is conceivable for an optical interface according to the invention to use visible light (wavelength range: 400-780 nm), in principle, but optical interfaces for infrared or ultraviolet light are also conceivable. In particular, the choice of the frequency for the light may be designed to have as little interference as possible, e.g. to be absorbed, in the working space of the household appliance in the presence of water, for example.

Data transmission apparatuses having optical interfaces according to the invention thus comprise appropriate sending and/or receiving units, for example. In one simple embodiment of the invention, these may be in the form of a photodiode on one side and in the form of a phototransistor on the other side, for example. Optical couplers can also be used as optical interfaces in embodiments of the invention. It is furthermore conceivable both to allow the transmission of light to take place through the air and to use optical fibers or fiber optic lines, which particularly has the advantage that spray or infiltrate water, for example, which gets onto the lines does not influence the transmission of the light, or at least influences it only a little. The use of, in principle, all types of light transmission and all types of sending and/or receiving units for light is conceivable.

In one advantageous development of the invention, the household appliance contains at least one holding apparatus which can be used to hold a functional component, particularly in the working space of the household appliance. The functional component can thus be put into a position which is favorable for its operation. In addition, the optical interface may also be oriented such that the transmission of light to or from the functional component is guided specifically in the direction of a further optical interface.

It is particularly advantageous to equip the relevant holding apparatus such that it itself comprises the data transmission apparatus or optical interface. In this case, the functional component may be in a form such that its data transmission apparatus is arranged precisely at the relevant location in order to communicate with the data transmission apparatus in the holding apparatus. The advantage can be seen in that the transmission path may be very short, if appropriate practically zero, and also that this allows the risk of interfering influences, e.g. as a result of spray on the transmission link, to be kept low. The holding apparatus may also be in a form such that shielding is provided for the data transmission apparatus or optical interface.

In one advantageous development of the invention, the optical interface also has further supplementary functions. In particular, it can be used as an optical measuring and/or display instrument, for example in connection with a storage tank. As a result of the optical properties of the medium stored therein, this allows the optical interface to be used to achieve the effect that the optical path to be negotiated is interrupted or can be completed depending on the filling level. By way of example, depending on the filling level, it is also possible to detect a change of intensity of the light, for example by virtue of absorption as a result of the stored medium in comparison with an empty tank, in which there is less absorption. The light refraction or reflection can also be measured and utilized in order to obtain information about the filling level.

In addition, it is also possible for the optical interface to be used as a display instrument. If necessary, the optical interface can also be used from a large number of sending and receiving locations, for example arranged as a matrix, some of which also have a measuring function, for example, while other sending points (e.g. optical fiber ends which are connected to a sending source) are used as a display.

### EXEMPLARY EMBODIMENT

An exemplary embodiment of the invention is shown in the drawing and is explained in more detail below with reference to further details and advantages.

### Specifically:

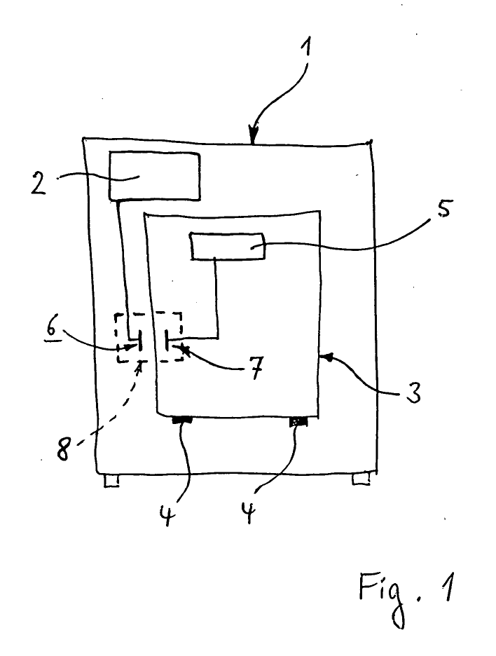

FIG. 1 shows a schematic illustration of a dishwasher with a combined dosing apparatus incorporated in the loading door,

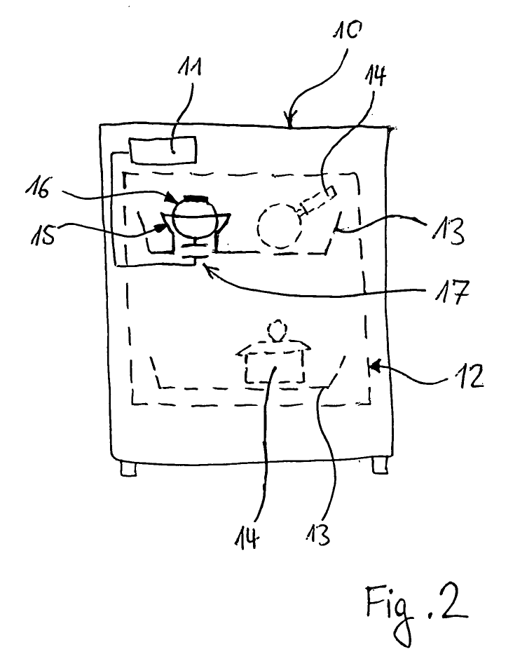

FIG. 2 shows a schematic illustration of a dishwasher with a dosing ball put into the working space,

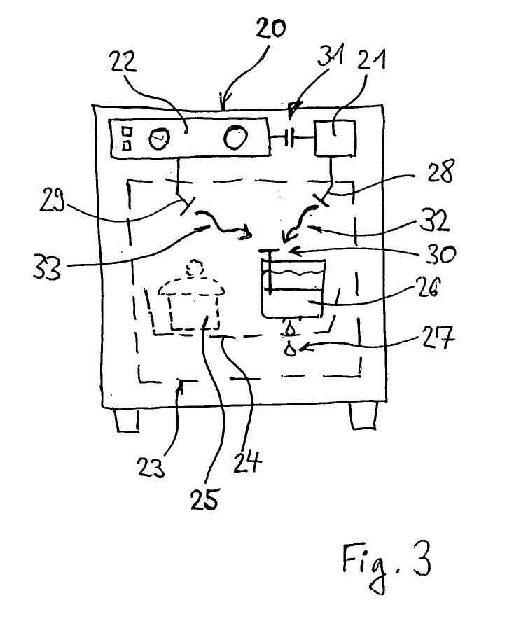

FIG. 3 shows a schematic illustration of a dishwasher with a control unit, control panel and dosing insert, and

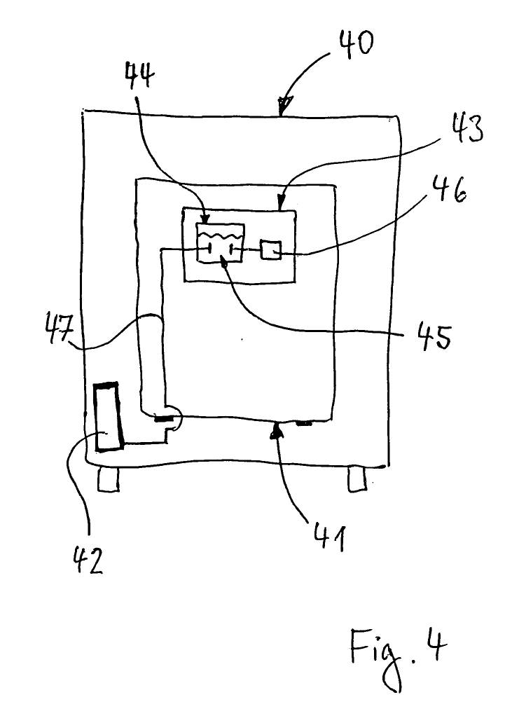

FIG. 4 shows a schematic illustration of a dishwasher with an optical interface with supplementary functions.

FIG. 1 shows a dishwasher 1 with a central controller 2 for controlling the dishwasher 1 or the execution of the wash program. In addition, the dishwasher 1 comprises a loading door 3 with hinges 4 which leads to a working space of the dishwasher 1. The tableware to be cleaned can be put into the working space; in addition, the tableware is cleaned in this working space. The loading door 3 has a permanently integrated combined dosing apparatus 5 incorporated in it. This doses or dispenses the detergent/dish detergent which is to be dosed into the working space during the cleaning process.

For the purpose of transmitting control commands from the central controller 2 of the household appliance to the combined dosing apparatus 5, respective optical interfaces 6, 7 are provided which form a data transmission apparatus 8. In this variant embodiment, it is advantageous that the transmission as seen from a design point of view, takes place from a stationary part of the household appliance 1 to a moving part, namely the loading door 3, which needs to be opened in order to place the tableware into the household appliance.

During the actual operation, in this case the cleaning process, the loading door 3 is closed, however, and is in its firm position. The transmission between the optical interfaces 6, 7 mounted in this manner is now possible, specifically when it is needed during operation. An electrical line run is not needed, and also electrical contacts which are interrupted when the loading door is opened are not necessary. Such electrical contacts could easily corrode, in particular, or be mechanically damaged by repeated opening and closing of the door, which can result in the conductive contact no longer being assured after a certain time. An electrical contact might also be accessible to be touched by the hand. Hence, this exemplary embodiment allows a particularly safe form of the invention with particularly safe handling. Furthermore, this embodiment allows a high level of durability. In addition, the data transmission apparatus can be used as a sensor for whether the door 3 is open or closed and hence can likewise additionally be a safety device, e.g. as a breaker for the power supply. In this regard, the optical interface may be coupled to a type of relay, for example, so that the electrical power supply is cut when the light path is interrupted.

FIG. 2 shows a dishwasher 10 with a control unit 11 and a working space 12. The working space 12 contains tableware baskets 13 for holding the tableware 14 which is to be cleaned. One of the tableware baskets 13 has an integrated holding apparatus 15 for holding or putting in a dosing ball 16. The dosing ball 16 supplies cleaning substances and has an optical interface on its underside. Furthermore, the holding apparatus 15 has an optical interface which is arranged in the base of the holding apparatus. Hence, the optical interface is largely protected from spray in the working space. The data transmission apparatuses 17 provide for a connection between the dosing ball 16 and the control unit 11.

By way of example, the dosing ball 16 may be capable of dosing upon a command from the control unit 11; depending on the embodiment, it may alternatively simply be open and empty itself during the operation of the household appliance. However, it may also be a straight friend/foe recognition system, for example, that is to say a coding, so that the optical interface is used only to recognize whether or not it is a dosing ball 16 which is approved for the operation of the dishwasher 10 and which contains approved detergent. This may additionally also be supported by a coding for the mechanical holding of the dosing ball. Alternatively, in one embodiment, the dosing ball 16 could comprise a filling level sensor system and indicate whether it is full or empty. In addition, a measuring apparatus could be integrated in the dosing ball 16 which forwards the measured conductance and temperature to the control unit 11, for example.

FIG. 3 shows a dishwasher 20 with a control unit 21 and an control panel 22, a working space 23, a tableware basket 24 and tableware 25 which has been put into the latter. In addition, the tableware basket 24 contains a machine-controlled dosing apparatus 26 which is in the form of a dosing insert and which dispenses liquid cleaner 27 via an outlet. The control unit 21 and the control panel 22 can each use the optical interfaces 28, 29, 30 to communicate with the dosing apparatus 26. Furthermore, the control unit 21 and the control panel 22 can communicate with one another using further optical interfaces or data transmission apparatuses 31 and can thus convey data or commands. In principle, it is also possible for communication to take place between the control unit 21 and the control panel 22 via the dosing insert 26, so that the latter forwards or processes and forwards data. The reference symbols 32, 33 denote signals.

By contrast, FIG. 4 shows a dishwasher 40 with a loading door 41, a control unit 42 for controlling the cleaning cycle of the dishwasher 40 and a combined dosing unit 43 which is integrated in the loading door 41. In addition, the combined dosing unit 43 comprises a tank 44 for liquid cleaner or rinse aid. An optical interface 45 is integrated in conjunction with this tank. To this end, the combined dosing unit contains a sending unit 46. The light is routed to the optical interface 45 or onward to one integrated in the control unit 42 via optical fibers 47.

The optical interface 45 can perform a series of supplementary functions: by way of example, it may be in the form of a filling level meter for the tank 44. In this context, the optical properties of the medium, e.g. the liquid cleaner or rinse aid, are used. The optical interface may be arranged or in a form such that the optical path which the light needs to negotiate beyond the optical interface is interrupted or not interrupted depending on whether or not the tank is filled. Alternatively, the optical fibers may be arranged such that refraction or reflection properties of the liquid cleaner or rinse aid are utilized and thus the filling level indication is made possible.

The optical interface 45 can also be used as a display apparatus, possibly even in addition to a further function such as that of the filling level meter. To this end, the optical interface can be arranged such that it can be perceived by the user when the loading door 41 is open, for example.

### LIST OF REFERENCE SYMBOLS

1 Dishwasher
2 Central controller
3 Loading door
4 Hinge
5 Combined dosing apparatus
6 Optical interface
7 Optical interface
8 Data transmission apparatus
9 Unassigned
10 Dishwasher
11 Control unit
12 Working space
13 Tableware baskets
14 Tableware
15 Holding apparatus
16 Dosing ball
17 Data transmission apparatus
18 Unassigned
19 Unassigned
20 Dishwasher
21 Control unit
22 Control panel
23 Working space
24 Tableware basket
25 Tableware
26 Dosing apparatus
27 Detergent
28 Optical interface
29 Optical interface
30 Optical interface
31 Data transmission apparatus
32 Light signal
33 Light signal
40 Dishwasher
41 Loading door
42 Control unit
43 Combined dosing unit
44 Tank
45 Optical interface
46 Sending unit
47 Optical fiber

What is claimed is:

1. Data transmission apparatus (8, 17, 31; 45, 46) for household appliances (1, 10, 20, 40), particularly washing machines, dishwashers or the like, for sending and/or receiving data between at least two functional components (2, 5, 11, 16, 21, 22, 26, 42, 43) for the household appliance, characterized in that the data transmission apparatus has an optical interface (6, 7, 17, 28, 29, 30, 31, 45).

2. Data transmission apparatus according to claim 1, characterized in that at least one of the functional components is permanently installed in the household appliance.

3. Data transmission apparatus according to one of the preceding claims, characterized in that at least one of the functional components permanently installed in the household appliance is in the form of one of the following apparatuses:
a combined dosing apparatus (5, 43) for dosing a detergent or dish detergent,
a control unit (2, 11, 21, 42) for controlling the household appliance, particularly for controlling and/or regulating a wash program, the dosing, the wash duration, washing parameters, etc.
a control panel (22) on the household appliance for the user to set control parameters, e.g. for the wash program, wash duration, wash temperature, etc.

4. Data transmission apparatus according to one of the preceding claims, characterized in that at least one of the functional components is not permanently installed in the household appliance.

5. Data transmission apparatus according to one of the preceding claims, characterized in that at least one of the functional components which is not permanently installed in the household appliance is in the form of one of the following apparatuses:
a dosing apparatus (26) in the form of a dosing insert,
a supply receptacle (16) for supplying a detergent, dish detergent or the like,
a measuring apparatus for determining measured variables such as wash parameters, for example conductance, temperature, pH value, etc.
a control apparatus for controlling the working program of the household appliance, e.g. the cleaning program.

6. Data transmission apparatus according to one of the preceding claims, characterized in that the optical interface (45) is in the form of a measuring and/or display apparatus.

7. Data transmission apparatus according to one of the preceding claims, characterized in that the optical interface (45) is in the form of a filling level meter for a storage tank.

8. Functional component (2, 5, 11, 16, 21, 22, 26) for a household appliance (1, 10, 20), characterized in that it comprises a data transmission apparatus according to one of the preceding claims.

9. Functional component according to one of the preceding claims, characterized in that the functional component is permanently installed in a household appliance, particularly a combined dosing apparatus for dosing a detergent or dish detergent, control unit for controlling the household appliance, control panel on the household appliance for the user to set control parameters, or the like.

10. Functional component according to one of the preceding claims, characterized in that the functional component is not permanently installed in the household appliance.

11. Functional component according to one of the preceding claims, characterized in that the functional component which is not permanently installed in the household appliance is designed to be put into a holding apparatus of the household appliance.

12. Household appliance (1, 10, 20, 40), particularly washing machine, dishwasher or the like, characterized in that there is at least one functional component according to one of the preceding claims which is permanently installed in the household appliance and/or at least one data transmission apparatus according to one of the preceding claims.

13. Household appliance according to one of the preceding claims, characterized in that a holding apparatus (15) is provided for holding the functional component.

14. Household appliance according to one of the preceding claims, characterized in that the holding apparatus (15) comprises a data transmission apparatus (17) according to one of the preceding claims.
